(19) United States
(12) Patent Application Publication
(10) Pub. No.: US 2024/0381511 A1
(43) Pub. Date: Nov. 14, 2024

(54) GLARE REDUCTION SYSTEM

(71) Applicant: HIVIZ LIGHTING, INC., Hendersonville, NC (US)

(72) Inventor: Samuel T. Massa, Hendersonville, NC (US)

(73) Assignee: HIVIZ LIGHTING, INC., Hendersonville, NC (US)

(21) Appl. No.: 18/691,836

(22) PCT Filed: Sep. 14, 2022
(86) PCT No.: PCT/US2022/076438

§ 371 Date: Mar. 13, 2024

Related U.S. Application Data
(60) Provisional application No. 63/243,942, filed on Sep. 14, 2021.

(51) Int. Cl. H05B 47/115; B60Q 1/14; F21V 23/04; H05B 47/155; H05B 47/175

(52) U.S. Cl. CPC H05B 47/115; B60Q 1/1423; F21V 23/0471; H05B 47/155; H05B 47/175; B60Q 2300/45

(57) ABSTRACT

A glare reduction system includes an illumination module configured to illuminate an illumination channel. The glare reduction system further includes a sensor module configured to sense movement with a sensor zone and a processing module in operative communication with the illumination module and the sensor module. The processing module is programmed to reduce illumination in an illumination channel when the sensor module senses movement of a person within the sensor zone.

### CROSS-REFERENCE(S) TO RELATED APPLICATION

This application claims the benefit of Provisional Application No. 63/243,942, filed Sep. 14, 2021, which is herein incorporated by reference in its entirety.

### BACKGROUND

Emergency vehicles such as police cars, fire trucks, and ambulances often have emergency signaling systems mounted on them. Typically, these systems include emergency signaling lights that may flash in various colors and patterns, as well as sirens or public address loudspeakers. These devices enable emergency services personnel such as police officers, firefighters, emergency medical technicians (EMTs), and other first responders to warn people in the vicinity of the emergency vehicles that the vehicles are approaching and/or that there is a dangerous situation which is being handled by the emergency services personnel. Emergency vehicles are also typically equipped with illuminating lighting to provide constant illumination in work areas around the vehicle in which emergency services personnel perform various tasks.

FIGS. 1A and 1B show an example of an emergency vehicle 20. In the illustrated embodiment, the emergency vehicle 20 is shown as an ambulance. Side lights 22 are mounted to the vehicle to illuminate a side illumination zone 24 on each side of the vehicle 20, and rear lights 26 that illuminate a rear illumination zone 28. As best shown in FIG. 1A, when people, such as an emergency responder 32 and/or a patient/victim 30 approach vehicle, they travel through an illumination zone while moving toward the light. e.g., through illumination zone 28 and toward lights 26.

When a person enters an illumination zone, particularly when moving towards an associated light, the intensity of the light can create a glarer for that person. This glare can be uncomfortable and also can also make it difficult to work within the illumination zone. For example, the lights on a firetruck can make it difficult for firemen to work around the firetruck while retrieving tools and other equipment.

Currently, there are a number of solutions for glare control in lighting systems. Some of these solutions attempt to dim the primary light source in response to any user motion detected in a sensor zone, but these solutions fail to meet the needs of the industry because they can incorrectly reduce illumination intensity in the work area while the user is working. Other solutions attempt to dim based on user distance from the light source, but these solutions are similarly unable to meet the needs of the industry because they can reduce illumination in the work area when the user is working within the detection area. Additionally, distance-based systems reduce illumination in the work area while the user is within the dimming distance but moving away from the sensor and light source which are the conditions where the user needs maximum illumination of the illuminated area. Still, other solutions seek to allow the user to manually adjust the brightness of one or more channels of an illumination source in an attempt to balance the need for maximum workspace illumination with the desire for reduced glare, but these solutions also fail to meet industry needs because these static settings do not respond to user actions and may inadvertently allow illumination levels in the work area to be dimmed below the minimum illumination requirement guidelines for the active work area.

### SUMMARY

Embodiments of the disclosed glare reduction provide a work area illumination system that can reduce user-experienced glare from the illumination system when a user is approaching the light source. The disclosed system also allows a user to work in the illuminated area at increased brightness while working and not approaching the light source. Existing systems may only recognize the presence of a user to dim the illumination source, resulting in reduced illumination in the work area while the user is working. Still, further, the present system ramps up over a time period from dim to bright slowly enough to allow the user's vision to adjust to the change in brightness, minimizing the glare experienced by the user. Additionally, the disclosed lighting system ramps down from working brightness to a dimmed glare reduction brightness level over a time sufficient to allow the user's vision to acclimate to the reduced illumination. Thus, the disclosed system provides an automated illumination control system with user location detection and direction of motion detection that maximizes work area illumination while reducing glare in a safe manner when the user is approaching the light source.

The present disclosure is directed to embodiments of a glare reduction system that reduces the optical glare experienced by users in an area illuminated by auxiliary lighting. In some embodiments, the glare reduction system includes: sensing to determine the location of the user within an illuminated area; signal conditioning to determine if the speed of the user toward the source of illumination is above a threshold speed for a required minimum amount of time; a controller producing control (dimming) signals to dim the illumination source for the work area when the user's speed toward the illumination source is above the speed and time thresholds; and an output communicating the dimming command to the auxiliary illumination unit. The controller ramps up the control signal from the high illumination level o the lower, dimmed illumination level over a time period ranging from as short as 0 milliseconds to as long as 30,.000 milliseconds to reach the desired dimming level.

Additionally, the glare reduction system ramps the dimming signal back to the desired maximum illumination level once the measured user speed toward the illumination source drops below a speed threshold for a specified period of time and the controller will update the glare reduction signal such that the illumination unit will return the illumination output to the previous output level of a time period of as short as 0 milliseconds to as long a period of 10,000 milliseconds. Note the speed threshold and time period threshold to disable dimming may differ from the thresholds to initiate dimming. Additionally, the system maybe configured to use different time periods for the ramp down period for dimming and the ramp up period for increased illumination levels.

The system may also have one or more of the following components: multiple sensors, which may include one or more each of PIR sensors, RFID sensors, radio signal receivers, camera, LIDAR, ultrasonic, microwave RF, laser distance, laser scanners, depth camera, or other similar sensors, to monitor the work area and areas adjacent to the work area; external sensor modules to enable the system to monitor a large work area; input signals from the illumination system to provide details about the expected coverage area, which may include installation height, aiming direction, tilt angle, light distribution patterns or other characteristics of the illumination source being controlled; additional signal processing to allow dimming levels to respond in a manner more complex than simple threshold, proportional response, for example, to the user speed toward the illumination source and or user distance from the illumination source; configurable time limits to limit how quickly the system comes up to full brightness when turned on, how quickly the system may shift from full illumination to dimmed state and how quickly the system may shift from the dimmed state back to full illumination; user adjustable inputs to allow setting of speed or time thresholds for dimming or removing dimming, data recording features for logging system usage; multiple dimming outputs to allow the dimming of multiple illumination sources, possible different light distribution patterns that illuminate different sections of the work area; one or more channels of illumination integrated with the glare reduction system to create a responsive auxiliary illumination system; or additional output modules to allow the sensed user information and or dimming signal information to be communicated to other systems for recording or additional processing; inputs that allow the system to respond to outside signals, which may include, but are not limited to, user detection information from other sensors, information from other glare reduction systems, commands from an external system, commands from the user, or configuration settings from a control panel, for example, to disable automatic dimming; or additional outputs to indicate the status of the system, which may include dimming enabled, current output state, or system settings for speed, distance or time thresholds.

Additionally, the system may receive and process information from external systems, vehicle notification systems or emergency service notification systems to generate triggers to adjust the output level of one or more channels of one or more illumination devices or to command the system to disable dimming on one or more illumination channels, including, but not limited to, disabling dimming on all channels.

Furthermore, the system may track, monitor or receive information from users that allow the system to determine the user's distance from the system or sensors, the users' direction of motion or the user's speed. This and related information may be collected by monitoring the user's location using one or more cameras, that may use structured light that can be detected by the camera or may be assisted by targets or reflectors on the user or user's equipment; may come from transmission from a device carried by the user, including, but not limited to, measured signals from the users' cellphone Wifi field strength, cell phone Bluetooth field strength or cell phone GPS location. Additionally, the user's cellphone may transmit measured signal strength from the glare reduction system's WiFi transmitters or Bluetooth transmitters. The system may also use multiple radio receivers to collect signals from the user's phone for determining the user's location, direction of motion or speed. Additionally, the system may include multiple transmitters to allow the user's cell phone to measure and report relative WiFi or Bluetooth signal strength or error rate from the system's one or more transmitters of one or more types to allow triangulation of the user to determine the user's location, direction of motion or distance from the system. BLE or other radio beacons may be mounted on the glare reduction system as well as one or more beacons that may be attached to the user's person, garments or equipment to facilitate user tracking as described previously.

The disclosed system is unique when compared with other known systems and solutions in that it provides a glare reduction system that may respond to the user location user speed and direction of user movement, providing full illumination while the user is working in the illuminated area while automatically dimming one or more illumination channels when the system detects the user is moving toward the light source at a speed greater than a specific threshold for a specified period of time. The speed threshold and time threshold are selected to allow the user to freely move about the work area without inadvertently triggering the dimming function. This ensures maximum illumination of the work area while providing reduced glare when the system determines the user is approaching the system sensors and or light sources.

The disclosed system is superior in that the overall architecture of the system is unique. More specifically, the system is unique due to the presence of (1) one or more sensors measuring user distance from the sensor or illumination unit allowing determination of user direction and speed; (2) inputs for multiple external sensors to access sensor information from multiple sensors to monitor the work area of an illumination system with a wide illumination pattern; (3) multiple outputs that allow the system to control multiple illumination sources with one or more channels of illumination in each module; (4) signal processing to respond to user distance and speed to reduce glare when needed while optimizing work area illumination when glare reduction is not needed; and (5) control limits on how quickly the system can change brightness levels.

Generally speaking, glare reduction system components are structured such that the user location and motion are detected and communicated to a processing unit, the processing unit then generates and transmits dimming request signals to an illumination module to adjust the output of one or more optical channels. Such an exemplary structure may allow the system to determine the appropriate circumstance for the system to reduce the output of one or more channels of illumination to reduce the glare experienced by the user. An exemplary system may dim the appropriate light output channels only when the user is approaching the light source, or light sources, at a minimum speed but should not request dimming if the user is moving toward the light source at a speed below the minimum speed, or is not moving, or is moving away from the light source or if the user is moving laterally with respect to the light source.

In an embodiment, a glare reduction system comprises an illumination module configured to illuminate an illumination channel. The glare reduction system further includes a sensor module configured to sense movement with a sensor zone and a processing module in operative communication with the illumination module and the sensor module. The processing module is programmed to reduce illumination in an illumination channel when the sensor module senses movement of a person within the sensor zone.

In any embodiment, the processing module is programmed to reduce illumination in the illumination channel from a first illumination level when the sensor module senses that the person is moving toward the sensor module at a speed faster than a threshold speed.

In any embodiment, the processing module is programmed return illumination in the illumination channel to the first illumination level after a predetermined amount of time.

In any embodiment, the processing module is programmed return illumination in the illumination channel to the first illumination level if the sensor module senses that the person is moving away from the sensor.

In any embodiment, the processing module is programmed to reduce illumination when the sensor module senses that the person is moving toward the sensor module at a speed faster than the threshold speed for a duration longer than a threshold duration.

In any embodiment, the glare reduction system further comprises at least one additional sensor module, each sensor module defining a sensor zone, wherein the processing module is programmed to reduce illumination in an illumination channel when at least one of sensor module senses movement of a person within the sensor zone.

In any embodiment, the processing module is programmed to reduce illumination in the illumination channel when one of the sensor modules senses that the person is moving toward the sensor module at a speed faster than a threshold speed.

In any embodiment, the processing module is programmed to reduce illumination when the one of the sensor modules senses that the person is moving toward the one of the sensor modules at a speed faster than the threshold speed for a duration longer than a threshold duration.

In any embodiment, the glare reduction system further comprises at least one additional illumination module, each illumination module defining at least one illumination channel, wherein the processing module is programmed to reduce illumination at least one of the illumination channels when the one of the sensor modules senses movement of a person towards the one of the sensor modules for a duration longer than the threshold duration.

In any embodiment, the glare reduction system further comprises a separate sensor module corresponding to each illumination module.

In any embodiment, the glare reduction system further comprises a separate processing module corresponding to each sensor module.

In any embodiment, the glare reduction system further comprises a system controller in operable communication with each of the processing modules, wherein the system controller programmed to control at least one of the processing modules in response to signals received by another of the processing modules from the corresponding sensor module.

In any embodiment, the processing module is in operative communication with a network.

In any embodiment, the glare reduction system is further configured to be mounted to a vehicle.

In an embodiment, a vehicle includes a plurality of glare reduction systems according to the present disclosure.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1A shows a profile view of an emergency vehicle with a known lighting configuration;

FIG. 1B shows an overhead view of the emergency vehicle of FIG. 1A;

FIG. 2A shows a profile view of an embodiment of a glare reduction system featuring a sensor module, a processing module, and an illumination channel;

FIG. 2B shows a profile view of another embodiment of a glare reduction system similar to that of FIG. 2A but with an external illumination module with one illumination channel;

FIG. 2C shows a profile view of another embodiment of a glare reduction system similar to that of FIG. 2B but with an external illumination module having three illumination channels;

FIG. 2D shows a profile view of another embodiment of a glare reduction system similar to that of FIG. 2C but with the sensed area divided into three sensor zones based on distance from the illumination module;

FIG. 2E shows a profile view of another embodiment of a glare reduction system similar to that of FIG. 2D showing the illumination channels and sensor zones;

FIG. 3A shows a profile view of illumination channels for an embodiment of a glare reduction system with a multiple channel illumination source;

FIG. 3B shows a profile view of the sensing zones for another embodiment of a glare reduction system with multiple sensing zones;

FIG. 3C is a profile view of an embodiment of a glare reduction system with the illumination channels of FIG. 2A and the sensing zones of FIG. 2B;

FIG. 3D shows a profile view of a sensor module illustrating multiple PIR sensors creating multiple zones;

FIG. 4 shows an overhead view of sensor zones for an embodiment of a sensor module embodiment;

FIG. 5 shows an overhead view of sensor zones for an embodiment of a sensor module with narrowed width sensor zones;

FIG. 6A shows an overhead view of an embodiment of a glare reduction system illustrating user motion toward the illumination module from the center of the monitored area;

FIG. 6B shows an overhead view of an embodiment of a glare reduction system similar to that of FIG. 6A, illustrating user motion toward the illumination module location from an edge of the monitored area;

FIG. 6C shows an overhead view of an embodiment of a glare reduction system similar to that of FIG. 6A, illustrating a user not moving in the sensed area;

FIG. 6D shows an overhead view of an embodiment of a glare reduction system similar to that of FIG. 6A, illustrating user motion laterally to the illumination module;

FIG. 6E shows an overhead view of an embodiment of a glare reduction system similar to that of FIG. 6A, illustrating user motion away from the illumination module;

FIG. 6F shows an overhead view of an embodiment of a glare reduction system similar to that of FIG. 6A, illustrating user motion toward the illumination module from outside of the sensed area;

FIG. 6G shows an overhead view of an embodiment of a glare reduction system similar to that of FIG. 6A, illustrating user motion toward the illumination module from outside of the sensed area;

FIG. 6H shows an overhead view of an embodiment of a glare reduction system similar to that of FIG. 6A, illustrating user low speed user motion toward the illumination module from the center of the sensed area;

FIG. 6I shows an overhead view of an embodiment of a glare reduction system similar to that of FIG. 6A, illustrating users at both location X and location Y, detected by the glare reduction system;

FIG. 7A shows an overhead view of an embodiment of a glare reduction system with two sensor modules, two processor modules, and two integrated illumination sources, and illustrates potential sensor coverage zones;

FIG. 7B shows an overhead view of an embodiment of a glare reduction system similar to that of FIG. 7A, but with three installation locations;

FIG. 7C shows an overhead view of an embodiment of a glare reduction system similar to that of FIG. 7B, but with communication between the processor modules;

FIG. 7D shows an overhead view of an embodiment of a glare reduction system similar to that shown in FIG. 7C but adding an external controller with network connection;

FIG. 8A illustrates an overhead view of the sensor zones and illumination channels for an embodiment of a glare reduction system with a single sensor module, one processor module and multiple external illumination modules with multiple channels;

FIG. 8B shows an embodiment of a glare reduction system similar to that of FIG. 8A, but with the processor module installed remotely from the sensor module;

FIG. 9A shows a chart of an illumination decrease response time;

FIG. 9B shows a chart of an illumination increase response time;

FIG. 10A shows a profile view of sensor zones for an embodiment of a glare reduction system with five sensor zones and illustrating a user at location X moving to location Y;

FIG. 10B shows a profile of a sensor module using three PIR sensors to monitor five sensor zones, also illustrating a user at location X moving to location Y;

FIG. 10C is a table showing thirty seconds of processor module data log reflecting the system behavior for the user motion described in FIGS. 11A and 11B;

FIG. 10D is a table showing thirty seconds of processor module data log reflecting the system behavior for the user motion described in FIG. 11A and

FIG. 11B but for an embodiment of a glare reduction system with a single channel external illumination module;

FIG. 11A shows a block diagram of the components of an embodiment of a glare reduction system paired with an external illumination module; and

FIG. 11B shows a block diagram of the components of an embodiment of a glare reduction system with an integrated illumination module.

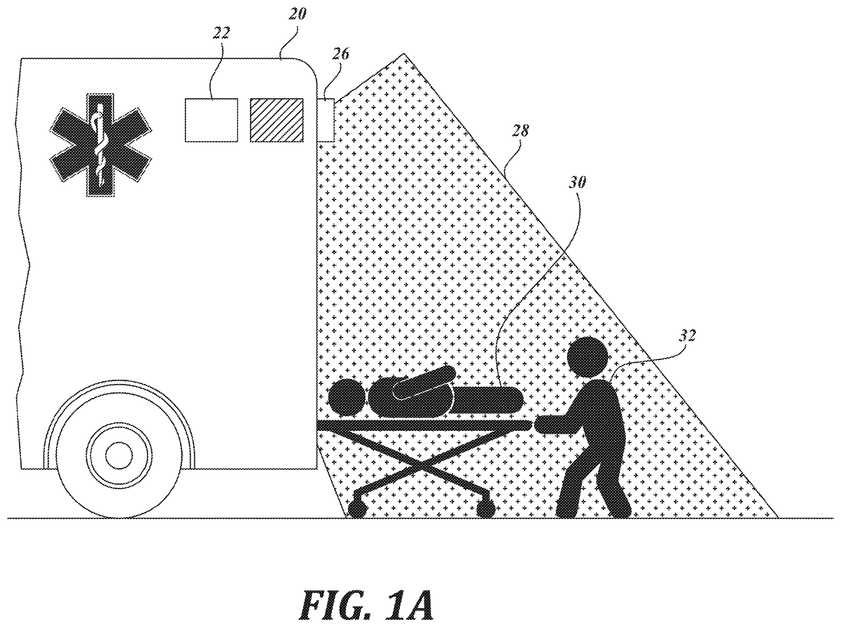

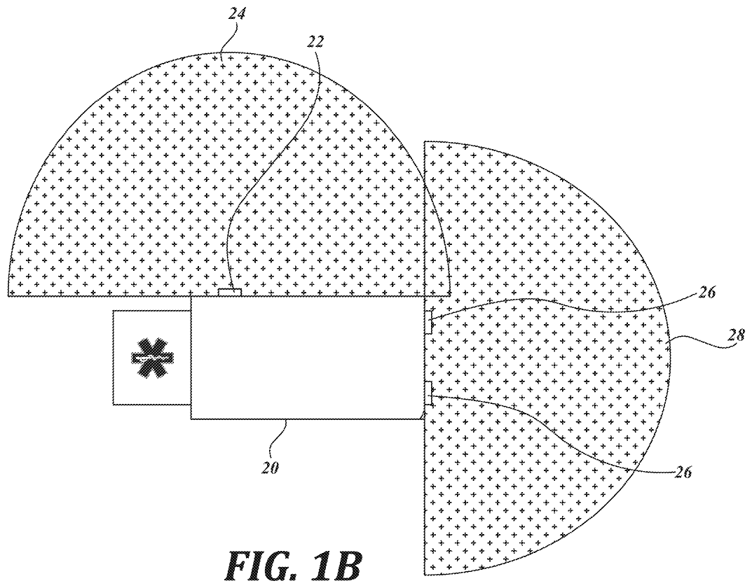

### DETAILED DESCRIPTION

The detailed description set forth herein in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

Various embodiment implementations of the present disclosure provide a glare reduction system. While embodiments of the disclosed glare reduction systems are generally described herein as being used in conjunction with emergency vehicles, it will be understood that these systems can be used in other applications, including offices, factories, commercial buildings, retail environments, or any other suitable environment.

In some embodiments, the glare reduction system is made up of the following components: a sensing module with multiple sensors; a processing module configured, e.g., programmed, to analyze sensor information and to map the sensed work area zone to work area illumination channels, to generate dimming triggers based on the content of received signals, to process input signals to generate dimming signals for multiple channels of illumination, to impose time limits on brightness changes, to transmit dimming signals to multiple illumination units and/or to transmit system status to other systems; one or more multiple channel illumination sources that respond to control messages or signals from the processing module; and a system controller to read user inputs to allow the user to configure the system, can receive and process signals from other systems, including information provided via internet connection or radio communications, can coordinate between multiple processor modules, sensor modules and illumination modules as well as displays system status.

In some embodiments, the system controller of the glare reduction system communicates with the processor modules, receives sensor module data, receives information from other glare reduction systems, and/or processes all of the available information to make dimming decisions for all available processor modules and illumination channels. In some embodiments the system controller then commands the update of the control signals for each illumination channel of each illumination module, updates the display on the system controller panel, updates dimming status outputs, transmits the system status to other glare reduction systems, and/or transmits the system status of the glare reduction system.

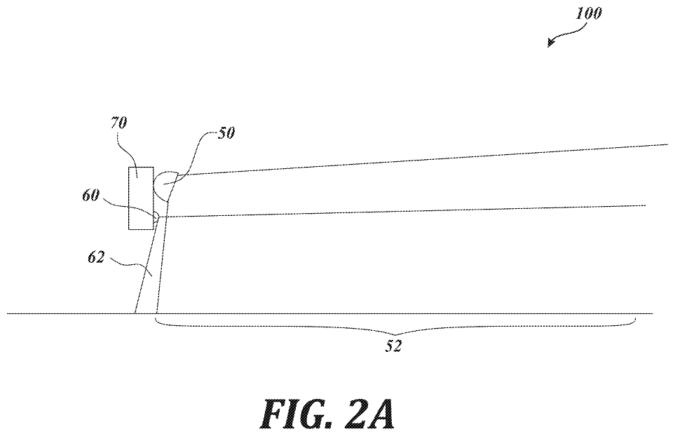

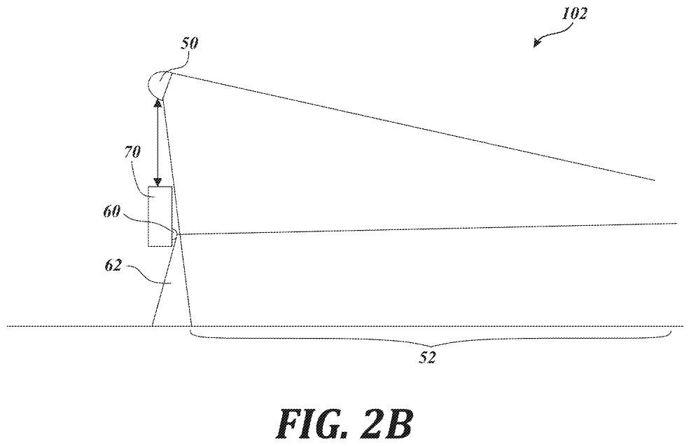

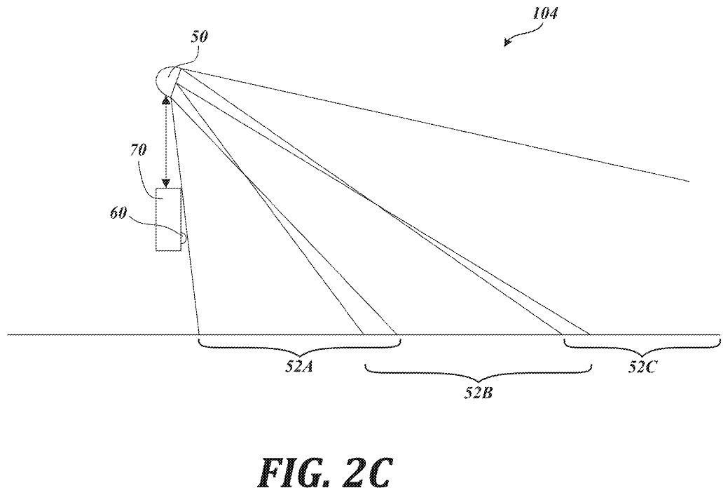

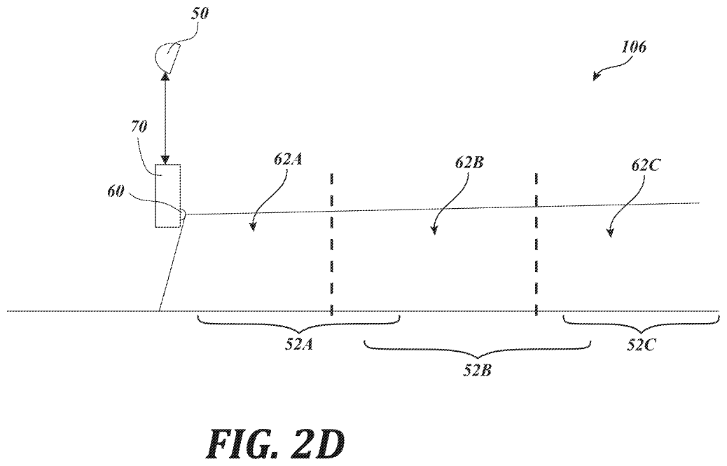

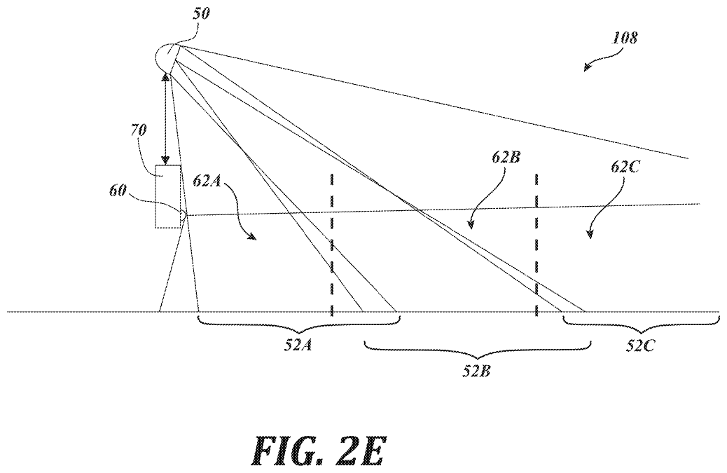

FIG. 2A depicts a profile view of an embodiment of a glare reduction system 100 that includes a single sensor module 60 configured to sense movement within a sensor zone 62 and to generate a signal corresponding to the sensed movement. A single processing module 70 is in operable communication with the sensor module 60 and configured to receive signals generated by the sensor module 60. The system 100 further comprises an illumination module 50 that illuminates a single illumination channel 52. The illumination module 50 is in operable communication with the processing module 70 that controls the illumination level of the illumination module 50 according to the signals received from the sensor module. In the illustrated embodiment, illuminated channel 52 (area) and the sensor zone 62 (are) are shown as being partially overlaid. In some embodiments, the illuminated area and sensed area vary to the degree that they overlap. In this regard, sensors may monitor areas that are not illuminated, and areas that are not monitored by sensors may be illuminated. Note the sensing, processing and illumination components may be integrated into a single device.

The sensor module output 60 is configured to sense the speed of a user, and in particular, the speed of a user moving toward the sensor module in the illuminated work area. The processing module 70 is configured to receive signals to from the sensor module 60 and is programmed to determine whether the user's speed toward the sensor is above a predetermined speed threshold for longer than a predetermined time threshold. If the user's speed is above the predetermined speed threshold for longer than the predetermined time threshold, then the processing module controls the illumination module 50 to dim the illumination channel 52, e.g., to reduce the lumens emitted by the illumination module. In some embodiments, the processing module 70 monitors the user speed while the illumination is dimmed and increase the brightness of the illumination channel if the user speed drops below a specified threshold for a specified amount of time. In some embodiments, the distance from the sensor to the user is also be used as a factor in determining the desired illumination level.

In some embodiment of disclosed glare reduction systems a microwave radar sensor is configured to determine the distance of a user from the sensor, a processor module processes the output of the microwave radar sensor, and the processor module controls the brightness of a collocated illumination module such that as a user approaches the sensor module at a speed above the system threshold, for a minimum duration, the illumination module is dimmed only enough to maintain a desired minimum illumination level at the user location. As the user approaches the glare reduction system sensor the illumination may be reduced gradually, ensuring minimal optical glare for the user while ensuring a minimum working illumination at the user location. In some embodiments, in addition to a continuously variable illumination level as the user moves toward the sensor, the glare reduction system may also be configured to divide the illuminated area into discrete zones based on distance from the sensor and provide differing illumination levels for each zone. In some embodiments, the single sensor module is a depth camera, time of flight camera, or other imaging device, or sensor, or combination of sensors, capable of measuring or indicating distance or depth.

FIG. 2B shows a profile view of an embodiment of a glare reduction system 102 similar to that of FIG. 2A but featuring an external illumination module 50, i.e., an illumination model 50 separate from the sensor module 60 and the processor module 70. The illumination module 50 responds to signals received from the processor module 70 to dim the illumination source. Communication between the processor module and the illumination module may be unidirectional from the processor to the illumination module or bidirectional. Additionally, the dimming request from the processor module may be made via data transmission, via voltage on an illumination module input, via pulse width modulation of an illumination module input, via pulse width modulation of the illumination module input power, or via any other suitable means.

FIG. 2C shows a profile view of a glare reduction system 104 similar to that of FIG. 2B but with an external illumination module 50 that produces three illumination channels 52A, 52B, and 52C. In some embodiments, the illumination channels overlap so that portions of the illuminated area are illuminated by more than one illumination channel. In the illustrated embodiment, sensor zones not shown here for clarity.

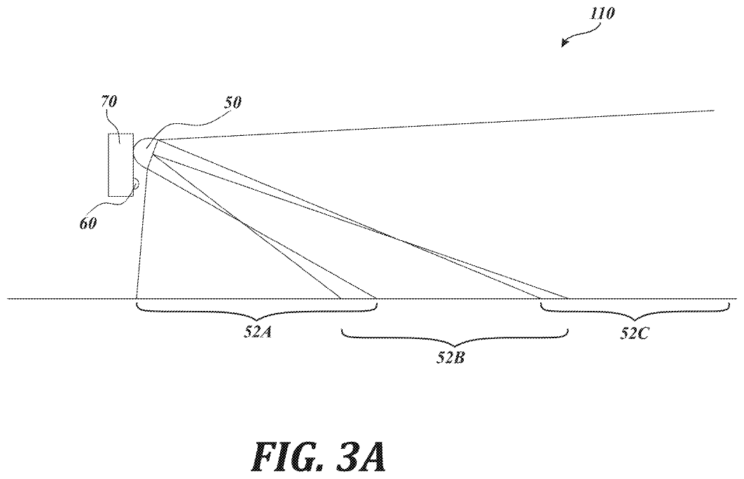

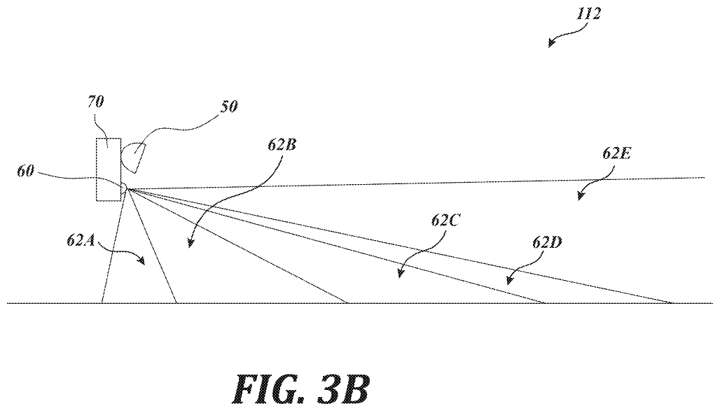

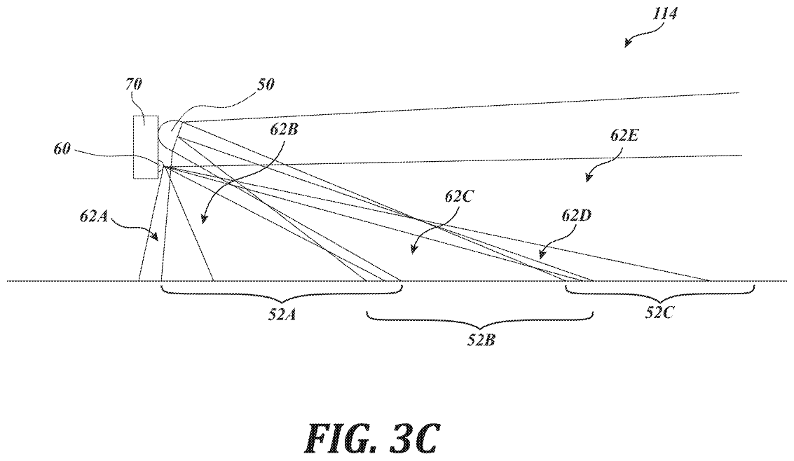

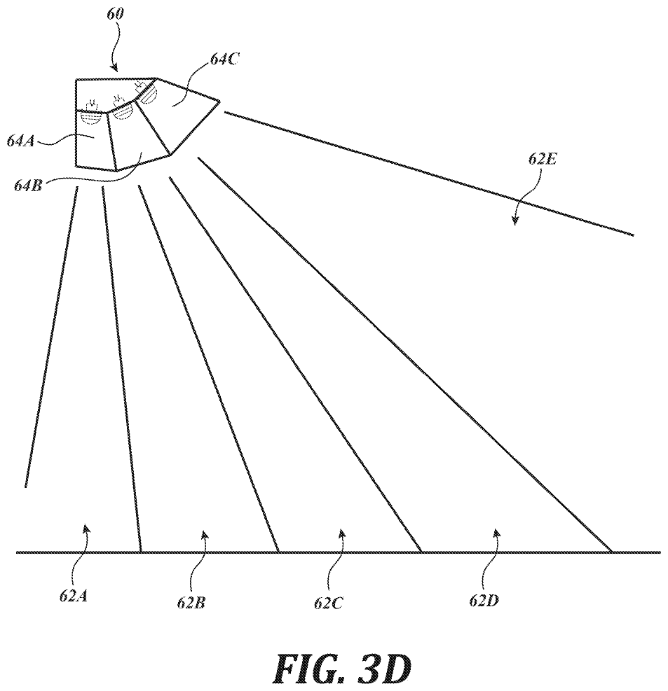

FIG. 2D shows a profile view of an embodiment of a glare reduction system 106 similar to that of FIG. 2C but showing only the sensor zones 62A, 62B, and 62C such that the monitored area is divided into three sensor zones, the borders of which are indicated by the dashed vertical lines, based on distance from the sensor module. The sensor module 60 includes sensors configured to measure distance to the user continuously throughout the monitored area, including, but not limited to, ultrasonic, microwave radar, depth camera, and time of flight cameras, allow zone division distances to be set at desired distances and to have the monitored area divided into any suitable number of sensor zones. This continuous measurement is in contrast to the discrete divisions of the monitored area that occur at transitions between individual sensor components of a sensor module with sensors for specific sensor zones, as shown in FIG. 3D for the PIR sensor component of a sensor module.

FIG. 2E shows a profile view of an embodiment of a glare reduction system 108 similar to that of FIGS. 2C and 2D. More specifically, the glare reduction system 108 includes an illumination module 50 that produces multiple illumination channels 52A, 52B, and 52C. Further, the sensor module 60 senses movement within multiple sensor zones 62A, 62B, and 62C. It will be appreciated that the number of illumination channels and sensor zones are exemplary only, and alternate embodiments in which different numbers of illumination channels and sensor zones are contemplated. In this regard, disclosed embodiments of glare reductions systems can include any suitable umber of illumination channels in combination of any suitable number of sensor zones are contemplated and should be considered within the scope of the present disclosure.

FIG. 3A illustrates a profile view of an embodiment of a glare reduction system 110 featuring a sensor module 60, processor module 70, and multiple channel illumination module 50 that produces multiple illumination channels 52A, 52B, and 52C that overlap for continuous illumination of the user area. In some embodiments, a specific location in the work area may be illuminated by a single illumination channel or a combination of multiple illumination channels. In some embodiments, illumination channels are generated by a single illumination source with multiple output channels. In some embodiments, illumination channels are provided by multiple illumination sources, that may or may not be mounted in proximity to one another,

FIG. 3B shows a profile view of an embodiment of a glare reduction system 112 wherein the sensor module 50 provides sensor coverage areas with multiple sensing zones 62A, 62B, and 62C, 62D, and 62E. In some embodiments, the sensor module 60 includes multiple sensors and is configured such that the zones depicted represent areas monitored by multiple discrete sensors that have overlapping sensed areas and, therefore, a specific location in a designated area may be monitored by multiple sensors in multiple sensor zones. In some embodiments, the sensor module monitors all of the designated area to be monitored using a single sensor that generates a continuous response across the monitored illuminated area.

FIG. 3C shows a profile view of a glare reduction system 114 having illumination channels described in FIG. 3A, overlaid with the sensor zones described in FIG. 3B. In some embodiments, sensors monitor areas that are not illuminated and areas that are not monitored by sensors may be illuminated.

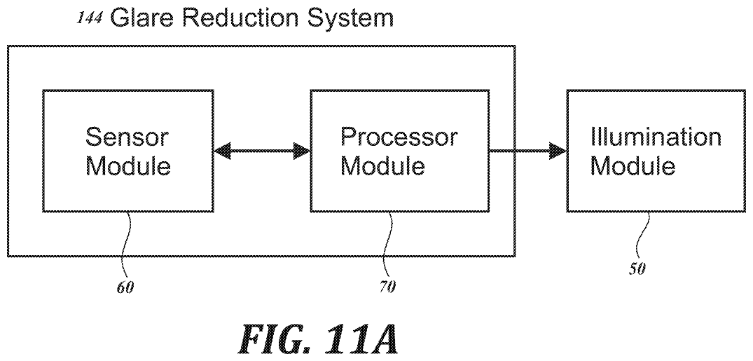

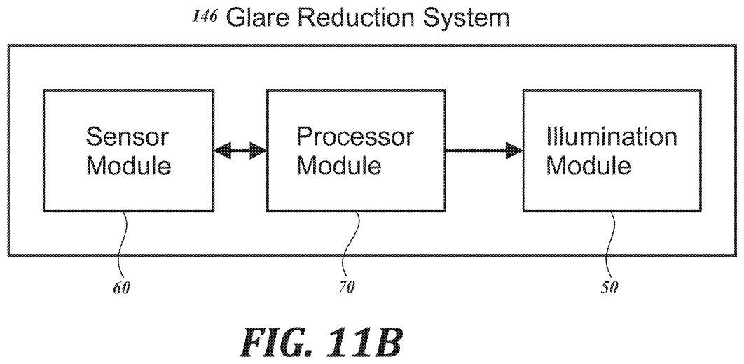

FIG. 3D shows a profile view of multiple Passive Infra-Red sensors 64A, 64B, an 64C (or any suitable number of sensors) mounted to create multiple sensor zones similar to the sensor zones shown in FIG. 3B. The individual PIR sensors 64A, 64B, an 64C are mounted with each sensor angled with respect to the other sensors such that each PIR sensor points at a different location within the monitored area. The processor module, not shown, reads the sensors and determines the current zone of the user based on motion detected by the PIR sensors. In some embodiments, the processor module reads discrete digital outputs from each PIR sensor, reads an analog output from the PIR sensor, and/or communicates with the PIR sensor via digital signal levels. In some embodiments, motion detected by both sensor 64A and sensor 64B indicates that the user is in motion in sensor zone 62B. The processor module determines the direction and speed of the user motion reported by PIR sensors by tracking the transition times between zones. FIGS. 11A and 11B, described below, illustrate exemplary embodiments of user motion tracking.

The area monitored by each PIR sensor is influenced by selection of the PIR sensor for the desired coverage angle, but the viewing angle of a PIR sensor may be reduced by placing light shields next to the PIR sensor to limit the field of view for that sensor. For example, using narrow coverage area PIR sensors, or using long light shields, user motion in sensor zone 3 may only be detected by PIR sensor B. Alternatively, using shorter dividers, or no dividers, and or using PIR sensors with broad coverage patterns, may allow user motion in sensor zone 3 to be detected as motion on sensors A, B, and C.

Note that sensors with different coverage areas, as well as different light shield lengths, may be used at each sensor position to customize the shape and size of the monitored area. Additional sensors may be added to create more sensor zones and higher resolution for user detection.

In some embodiments, multiple sets of vertically mounted PIR sensors are used to increase horizontal coverage. For example, a sensor module may use three sets of vertically mounted PIR sensors with one set pointing directly along the centerline of the monitored area, with a second set of PIR sensors aimed thirty degrees left of centerline of the monitored area, and a third set of vertically distributed PIR sensors aimed thirty degrees right of the centerline of the monitored area. This arrangement provides a broader horizontal coverage area.

In some embodiments, horizontal coverage and vertical coverage are implemented by mounting PIR sensors with tilt in more than one plane with respect to other sensors. For example, one embodiment mounts the PIR sensors on the faces of facets of one quarter of a faceted sphere, with additional facets and PIR sensors providing higher resolution monitoring of the coverage area.

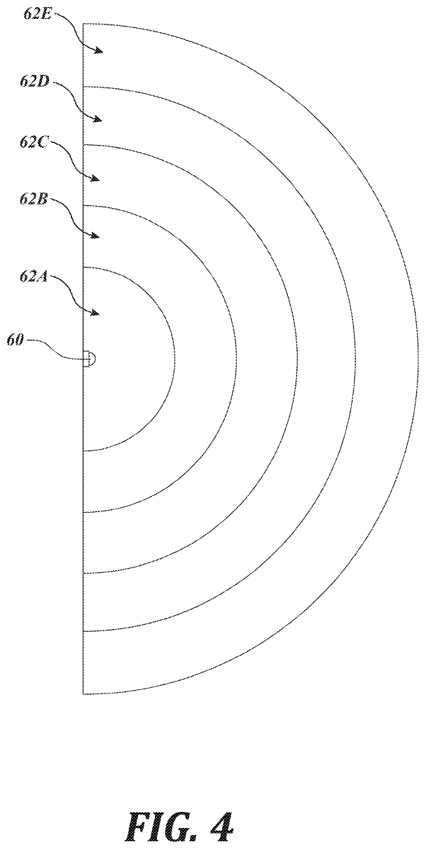

FIG. 4 illustrates an overhead view showing how work area zones 62A, 62B, 62C, 62D, and 62E (or any suitable number of ware area zones) are monitored by a sensor module 60 with a radial coverage pattern. In various contemplated embodiments, user distance, speed and direction are determined by measuring change in measured distance over change in time and/or by the transition time between monitored zones.

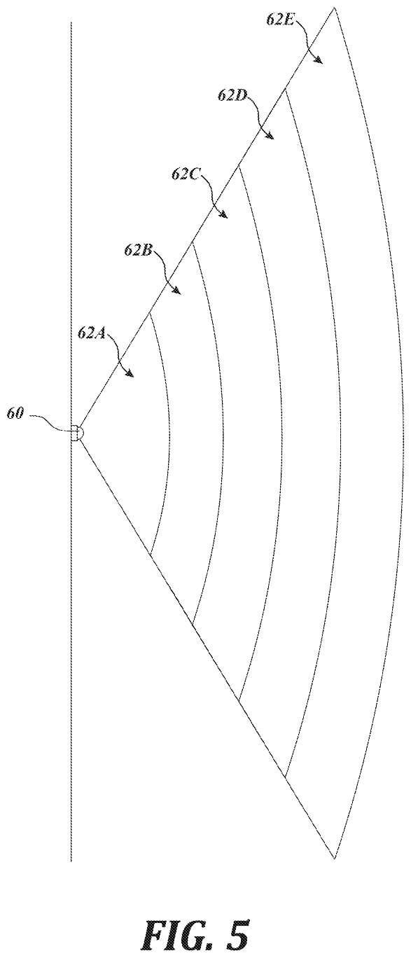

FIG. 5 illustrates an overhead view of a sensor module similar to that from FIG. 3 but configured with a narrower observation area. In various contemplated embodiments, the shape of the sensed area of the work zone is configured to provide prioritized monitoring of specific areas and/or prevent false triggering from areas that the user wants the glare reduction system to ignore.

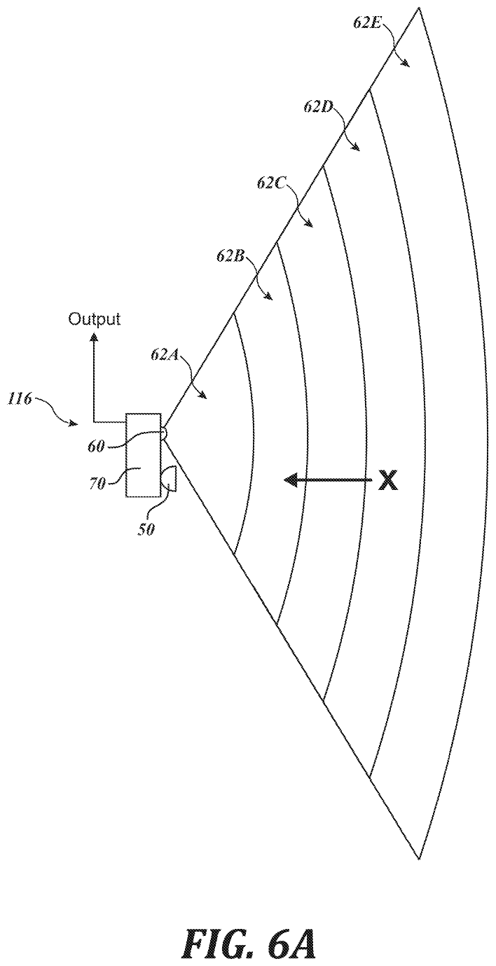

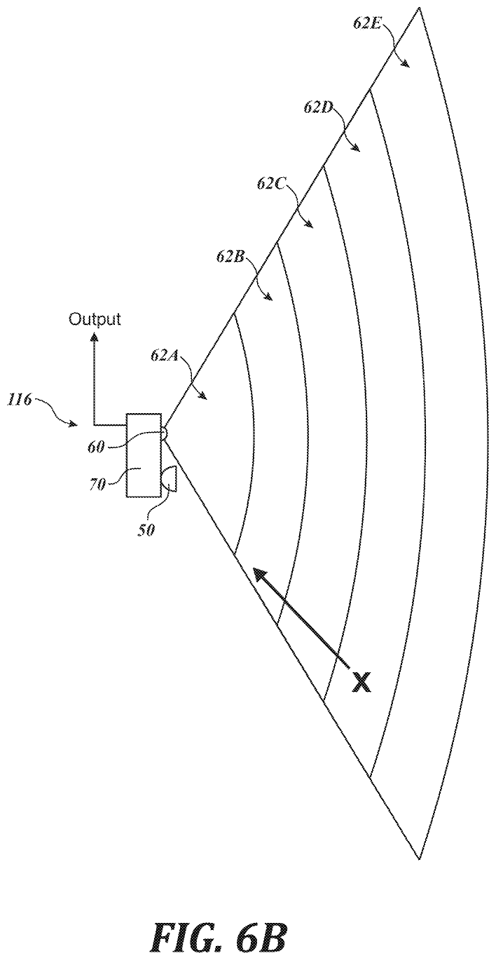

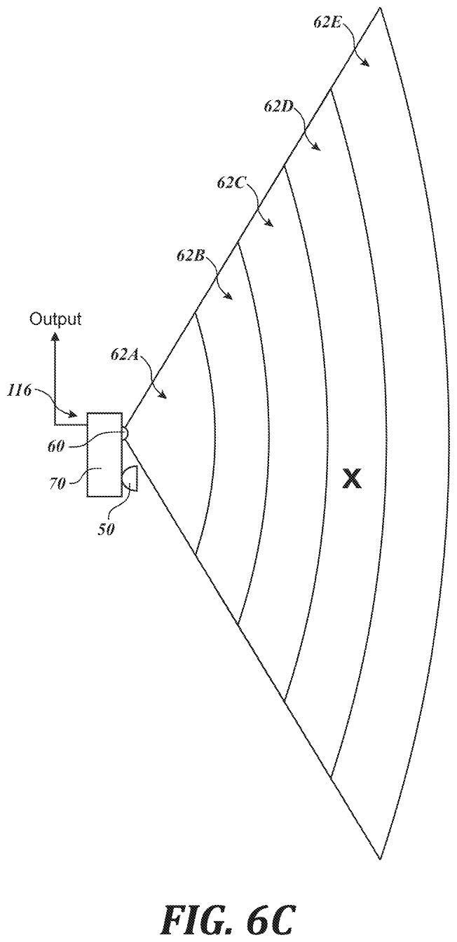

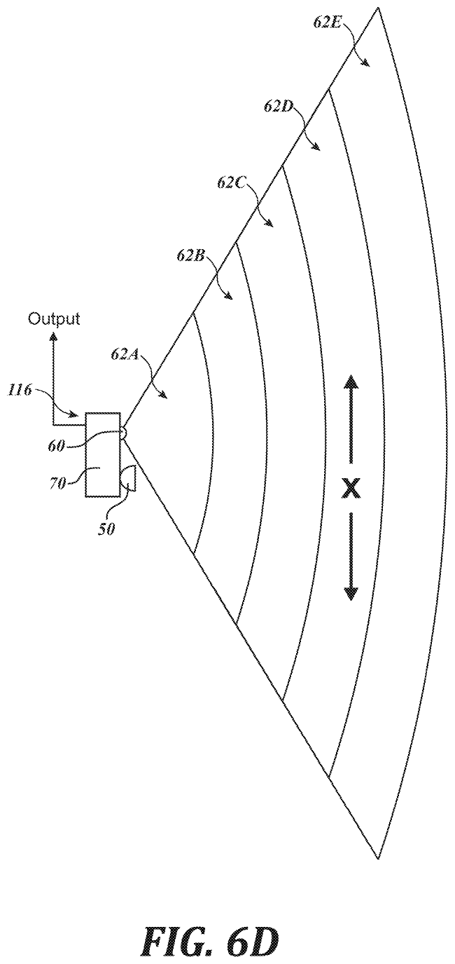

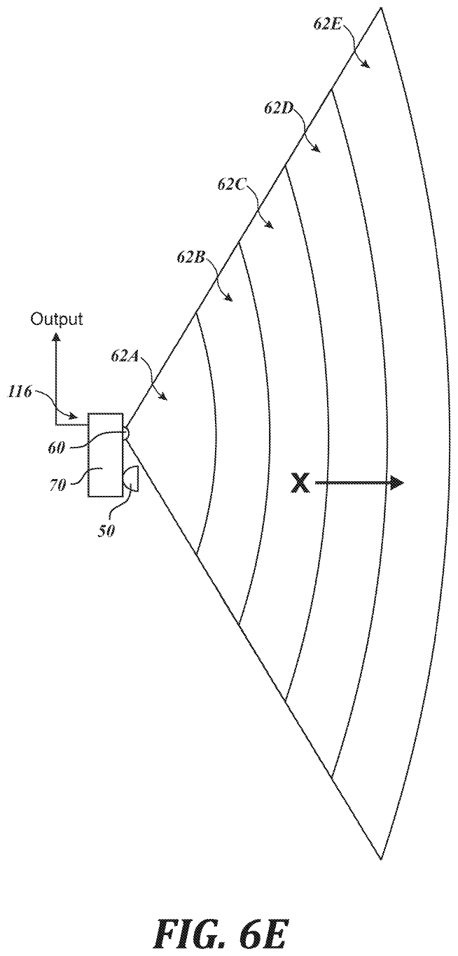

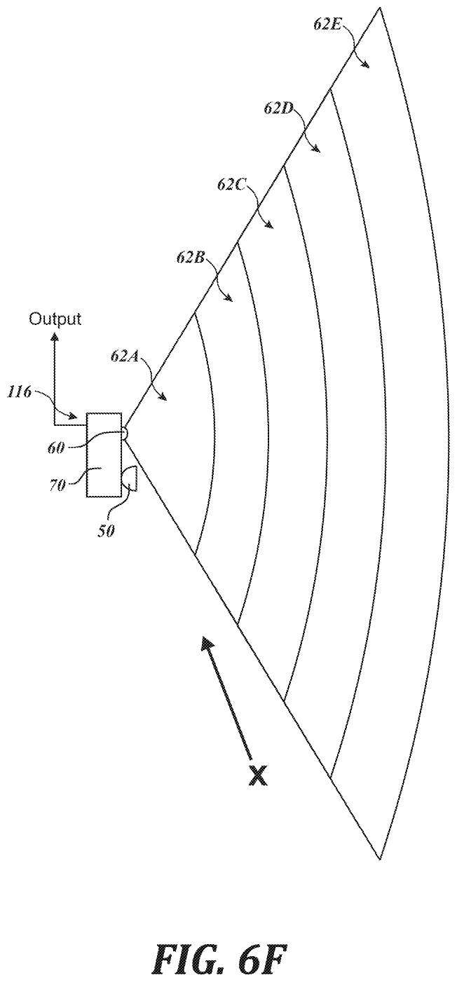

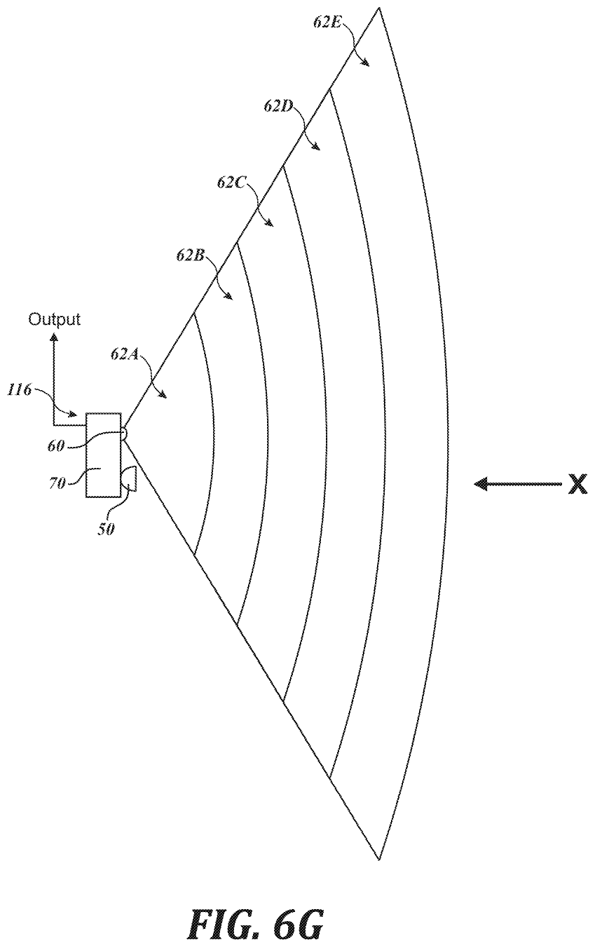

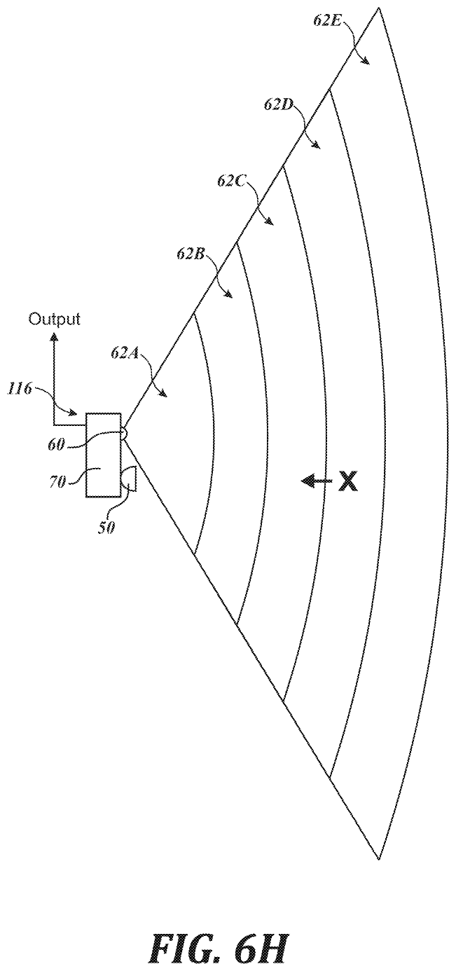

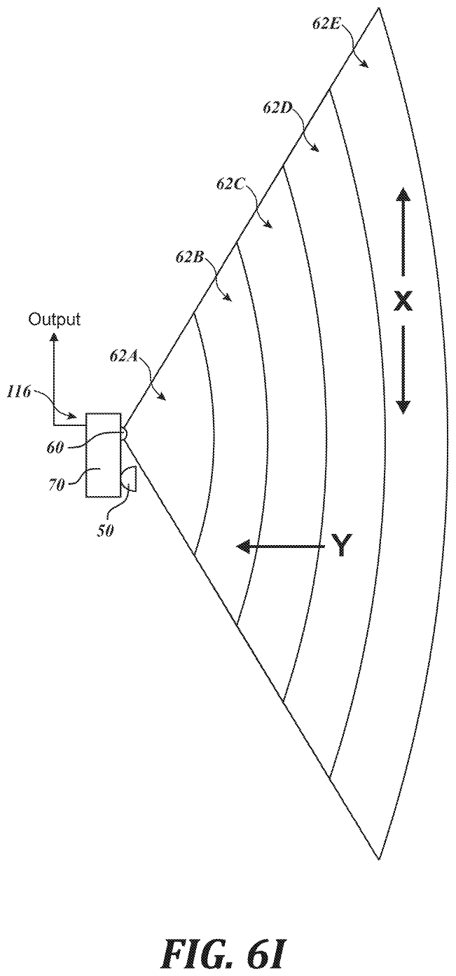

FIG. 6A illustrates an overhead view of another embodiment of a glare reduction system 116 featuring a sensor module 60, an integrated illumination module 50, and a processor module 70 with an output configured to request a reduction in output from an additional external illumination module, not shown. As a user moves from location “X” in sensor zone 62D toward the sensor module 60, the user moves from sensor zone 62D to sensor zone 62C and then to sensor zone 62B as the user approaches the illumination module 50. If the user is moving toward sensor module 60 (and thus, the illumination module 50) at a speed above the system speed threshold, for a duration longer than the system time threshold, the glare reduction system 116 requests dimming of the illumination module(s) 50. If the user motion toward the sensor module 60 (and thus, the illumination module 50) decreases below a predetermined speed threshold, for a time greater than a predetermined time threshold, the glare reduction system 116 returns the system to full brightness once the system dimming timeout elapses, unless another dimming trigger event occurs. In some embodiments, different speed and time thresholds are used for the dimming and undimming triggers. In some embodiments of a glare reduction system the sensor module and processor module are combined into a single device.

FIG. 6B illustrates the glare reduction system 116 of FIG. 6A and shows a representation of how a user moving from location “X” toward the illumination module would transition from sensor zone 62D to sensor zone 62C and on to sensor zone 62B when approaching the glare reduction system. If the user is moving toward the illumination module at a speed above the system speed threshold, for a duration longer than the system time threshold, the glare reduction system requests dimming of the illumination module.

FIG. 6C shows the glare reduction system 116 of FIG. 6A and illustrates an unmoving user at location X. As long as user motion toward the illumination module remains below the system speed threshold, the system does not request dimming. Should the illumination module be currently dimmed, the glare reduction system returns the illumination module to full brightness once the user motion has been below the system speed threshold for longer than the timeout threshold.

FIG. 6D shows the glare reduction system 116 of FIG. 6A and illustrates that a user at location X may move perpendicularly to the illumination module at a speed above the system speed threshold without the glare reduction system triggering a dimming request. The glare reduction system allows the user to work within the illuminated area without triggering undesired dimming requests Lateral movement that crosses sensor zone boundaries does not trigger a dimming request unless the speed component toward the illumination module is above the system speed for a period longer than the system time threshold.

FIG. 6E illustrates the glare reduction system 116 of FIG. 6A and shows a representation of how a user moving from location “X” away from the illumination module would transition from sensor zone 62C to sensor zone 62D and on to sensor zone 62E. The user may move away from the illumination module at a speed above the system speed threshold without triggering a dimming request.

FIG. 6F illustrates the glare reduction system 116 of FIG. 6A and shows a representation of how a user moving at location X, beyond the side edges of the system monitoring area, does not trigger a dimming request.

FIG. 6G illustrates the glare reduction system 116 of FIG. 6A and shows a representation of how a user moving a location X beyond the set limits of Sensor Zone 5, or beyond the sensing range of the sensor module, does not trigger a dimming request.

FIG. 6H illustrates the glare reduction system 116 of FIG. 6A and shows a representation of a user at location “X” moving toward the illumination module at a speed below the system speed threshold. This motion does not cause the glare reduction system to trigger a dimming request. Thus, the glare reduction system allows the user to work within the illuminated area without triggering undesired dimming requests as long as the motion toward the illumination module remains below the system speed threshold.

FIG. 6I shows the glare reduction system 112 of FIG. 6A, illustrating multiple users detected by the glare reduction system, at locations X and Y. If the users are in areas illuminated by separate illumination channels the system applies the appropriate dimming for each illumination channel. If the users are both in an area illuminated by a single illumination channel the system requests the highest illumination level that would be required from either user. That is, with two users illuminated by the same illumination channel, the system 116 will not request dimming unless both users meet the criteria for a dimming request. If either user in the illumination channel does not meet the dimming criteria the system does not request dimming of the illumination channel.

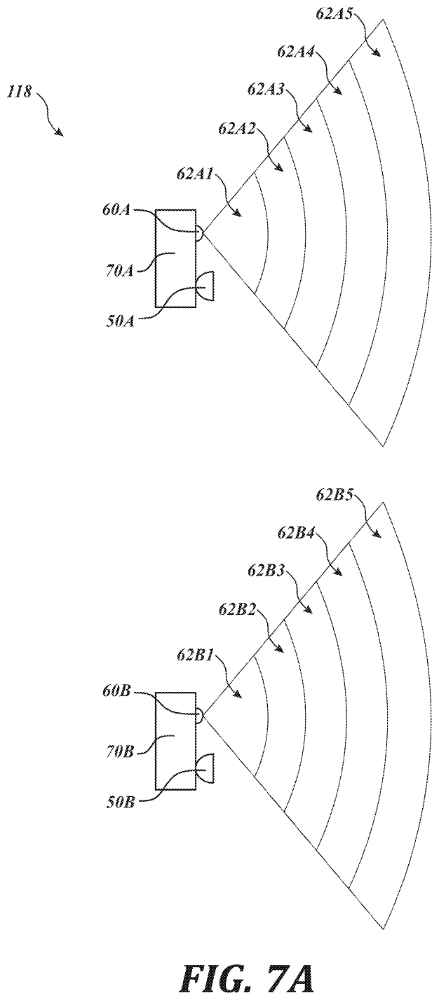

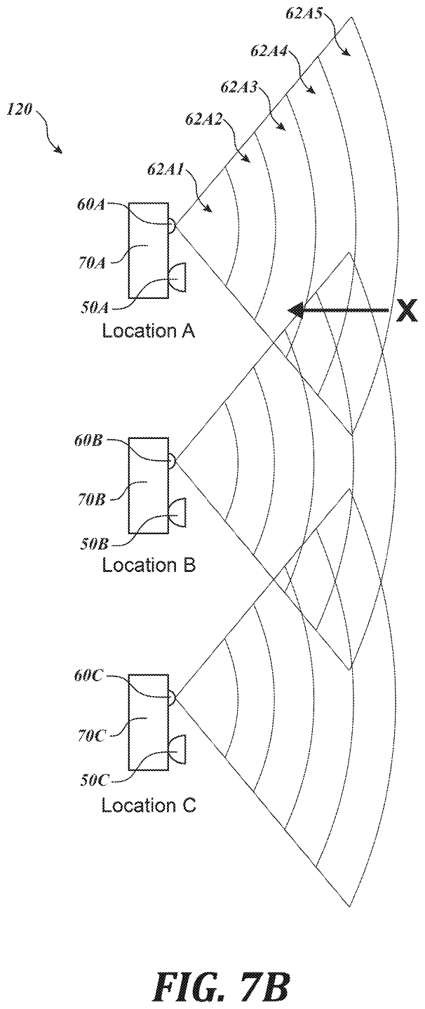

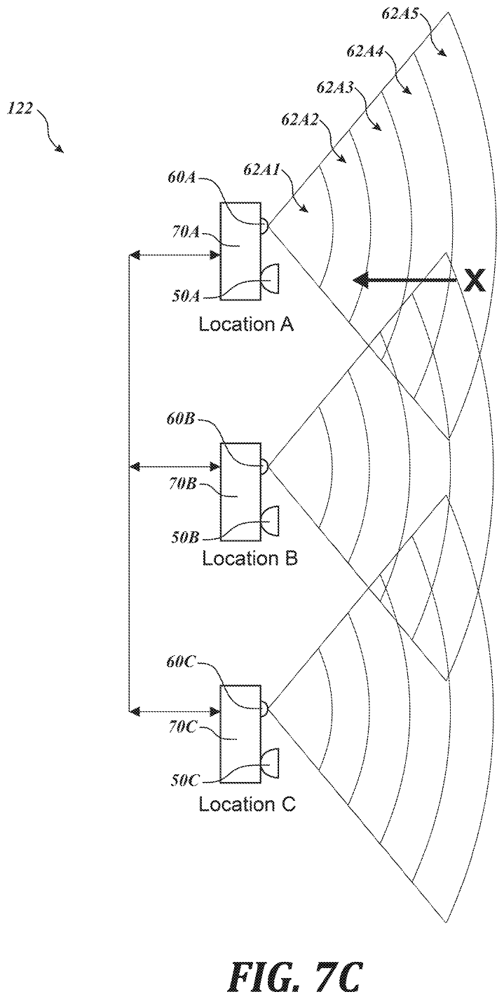

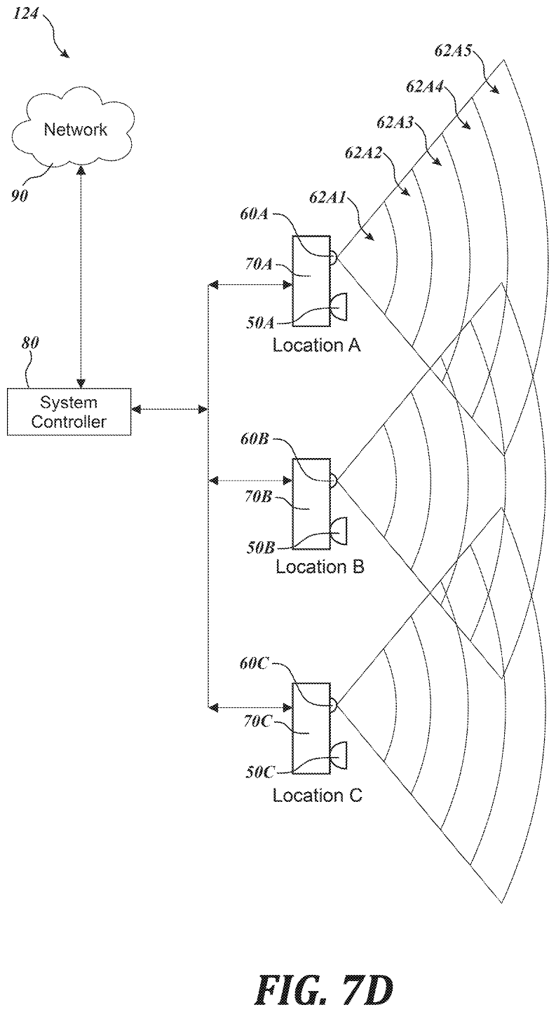

FIG. 7A shows an overhead view of a glare reduction system 118 with two installation locations. A and B, each with a sensor module 60A. 60B, respectively, a processor module 70A and 70B, respectively, and an integrated illumination module 50A and 50B, respectively, illustrating how large areas may be monitored. The output from each monitored zone sends a dimming request to the corresponding illumination module zone, requesting dimming of the appropriate illumination channel, or channels, when the trigger conditions for that zone are met.

FIG. 7B shows a glare reduction system 120 similar to that of FIG. 7A but with three monitored zones and shows a user at location X moving toward the installed locations. The sensing coverage and illumination coverage for adjacent installation locations overlaps. The coverage overlap means that a user at location X may trigger dimming requests from the processor modules for both location A and location B. Each installation location operates independently and uses the system thresholds for that location to determine dimming requests for the illumination channels for that location.

FIG. 7C shows a glare reduction system 122 similar to that of 7B with the addition of communication between monitored locations and the user motion being sensed by only location A. Communication between the processor modules allows the glare reduction system to be configured such that trigger events are shared between locations. In an embodiment, the system is configured such that triggering events in location A are shared with the other modules. Thus, a trigger in location A triggers dimming for the appropriate illumination channel for location A, while the processor module in location B is configured to respond to triggers from location A and dim the appropriate illumination channel of the illumination module for location B, while location C is configured to ignore the trigger from location A. The response of each processor module to triggers from other locations are configured such that different dimming percentages are for the illumination channels for that location depending on the trigger and which location generated the trigger. In some embodiments, the system is configured to dim the appropriate illumination channel, or channels, for all installation locations if any location generates a dimming trigger.

FIG. 7D shows a glare reduction system 124 similar to that of FIG. 7C with the addition of a system controller 80 with an external network connection 90. Embodiments of the system controller 80 and network connection 90 allow the glare reduction system 124 status to be monitored remotely, and the glare reduction system to respond to external triggers. In some embodiments, one external trigger is a no-dimming command that directs the glare reduction system to ignore dimming triggers until an external trigger countermanding the no-dimming command is received. Similarly, another external trigger directs the glare reduction system to dim specific channels at a specific location, or to set only specific illumination channels to the desired illumination level at specific locations.

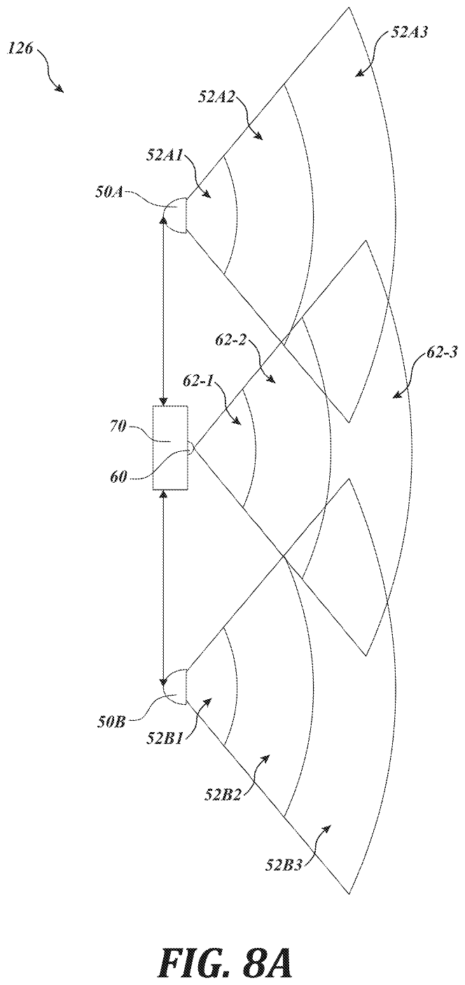

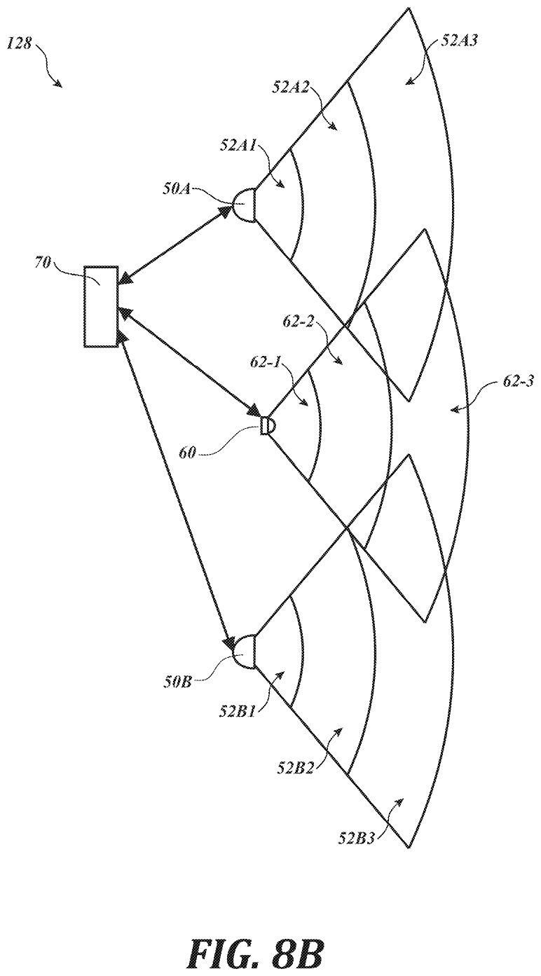

FIG. 8A is an overhead view of an auxiliary illumination system featuring a glare reduction system 126 and external illumination module 50A and 50Bs and shows how a single glare reduction system 126 may control multiple illumination modules 50A and 50B. In some embodiments, multiple illumination modules allow increased brightness levels or increased illumination coverage area. In some embodiments, the glare reduction system 126 is mounted to the side of the illuminated area or facing the illumination modules on the far side of the illuminated area, as long as user location, direction, and speed, relative to the illumination modules, may be determined.

FIG. 8B shows an overhead view of a glare reduction system 128 similar to that of FIG. 8A, but here the sensor module 60 and processor module 70 are mounted in separate locations with dimming request signals being routed from the processor to multiple external illumination modules 50A and 50B. In some embodiments, the sensor module 60 is implemented using several types of sensors, including but not limited to microwave radar, depth cameras, time-of-flight cameras, infrared cameras, or other sensor, or sensors, capable of measuring distance to a user, or sensors capable of collecting information that the processor module may use to calculate the distance to a user.

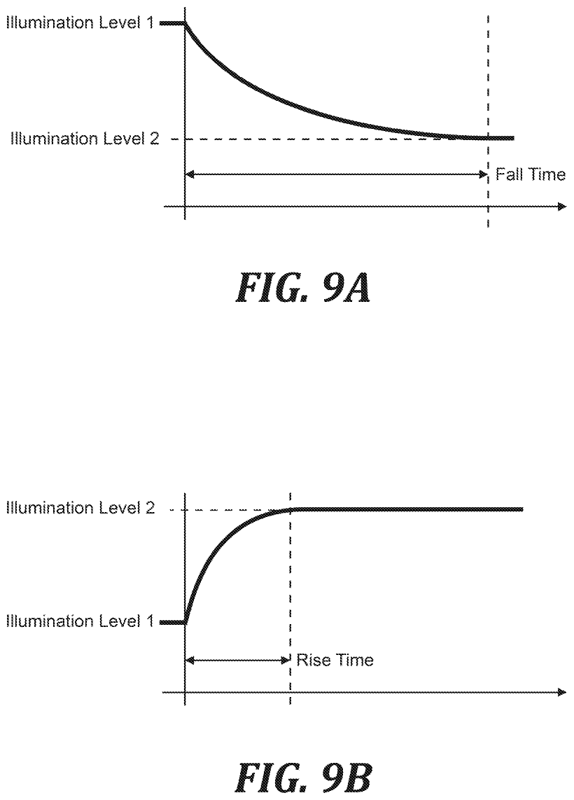

FIG. 9A is a graph showing how the illumination level of one or more illumination channels may be ramped down over time by the glare reduction system following a glare reduction trigger event. For illumination modules that support multiple dimming levels, the system reduces the illumination level from the brighter illumination Level 1 to the less bright illumination Level 2 over a time period to allow user vision to respond to the reduced illumination, with a ramp down time as short as 0 milliseconds, or as long as 30,000 milliseconds. Additionally, the glare reduction system may be configured to command reductions in illumination level at a speed that is a function of the amount of change in illumination requested and the starting illumination level. For example, the system may be configured such that a request for a decrease in illumination from 100 percent to 75 percent may be done over a different period than when dimming from 50 percent to 25 percent of maximum illumination.

Furthermore, decreases in illumination maybe linear, non-linear, or stepwise discreet changes in illumination value. Glare reduction system embodiments may support illumination modules with illumination control inputs including, but not limited to, multiple discrete digital dimming inputs, analog input voltage, digital input pulse width modulation, input power pulse width modulation and digital communications.

FIG. 9B shows a graph illustrating an example of how the glare reduction system may be configured to return an illumination channel to the desired full illumination level over a period of time to further reduce perceived glare. The system may return to the full illumination brightness following a timeout of the system's configured dimming timeout period if no new dimming trigger events occur. Additionally, if so configured, the system may return to full illumination brightness if a user is detected moving away from the sensor module, at a speed greater than a configured minimum speed, without waiting for the dimming timeout period. The system may reduce perceived glare by gradually returning to full illumination brightness over a time period to allow a user's vision to respond to the increasing brightness, with a ramp up time from as short as 0 milliseconds, or as long as 10,000 milliseconds. Furthermore, the system may be configured such that the amount of time used to increase the system brightness be based on the current illumination level and the amount of increased illumination requested, For example, a request for an illumination increase from 25 percent to 50 percent may be done over a different period than an increase from 75 percent to 100 percent of the maximum illumination.

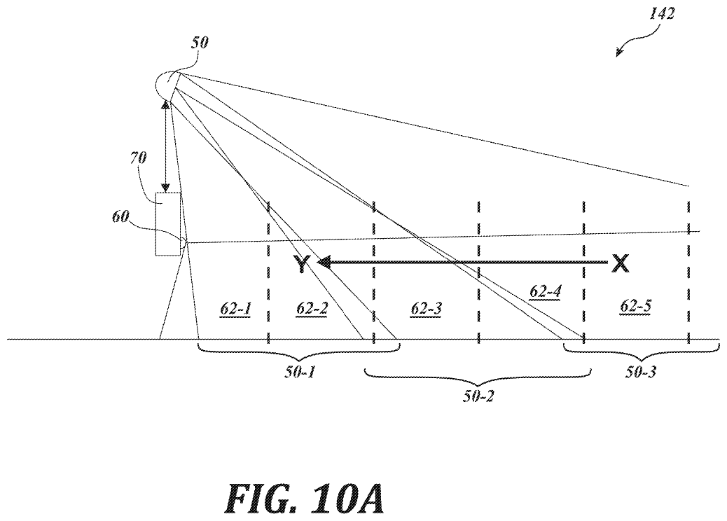

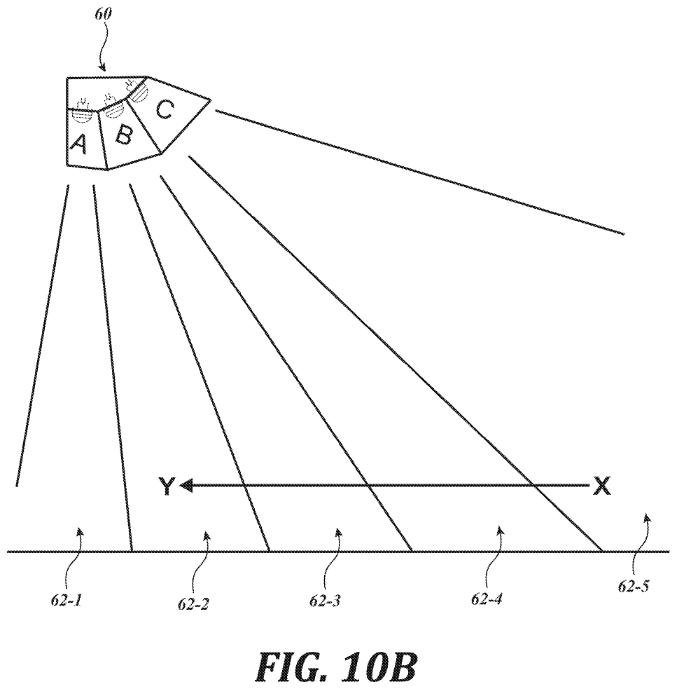

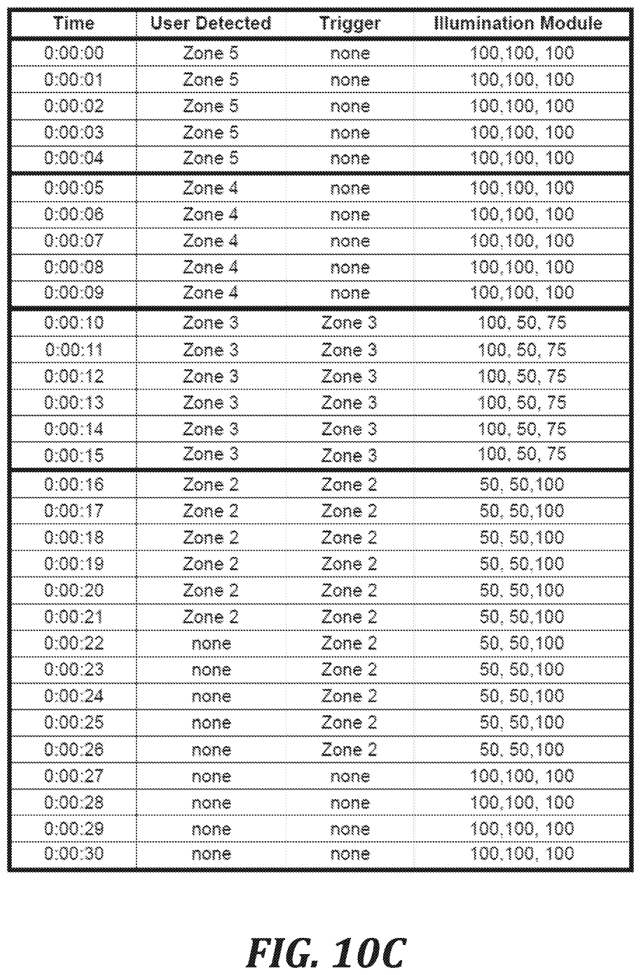

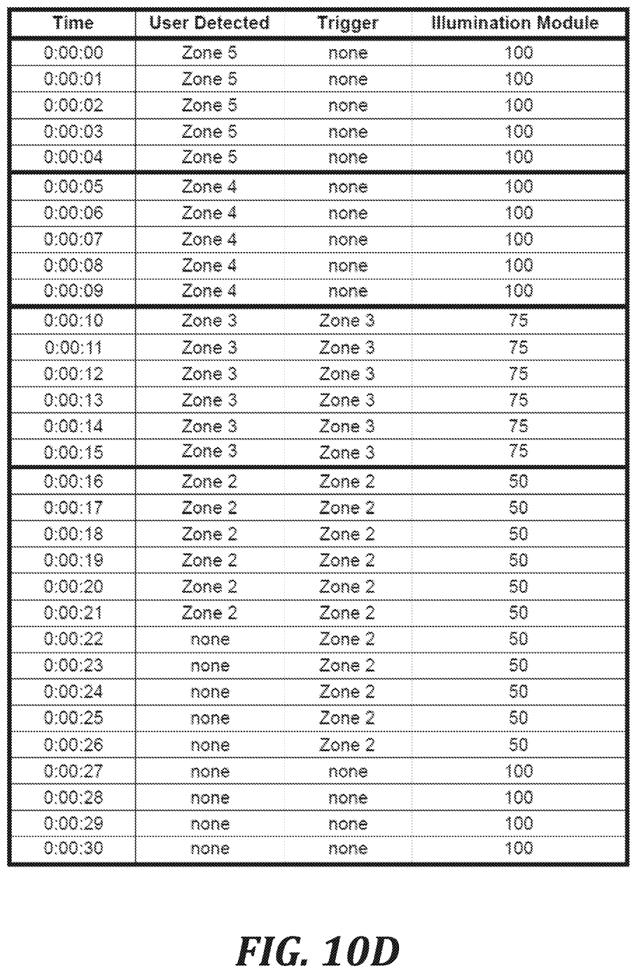

FIG. 10A a glare reduction system 142 with sensor zones 62-1 through 62-5 demarcated by dashed lines. FIG. 10A further illustrates a user moving from location X to location Y. The glare reduction system 142 is paired with an external illumination module 50 with three dimmable illumination channels 50-1, 50-2, and 50-3. The illustrated configuration lends itself toward sensors capable of line-of-sight measurements of distance to the user that are frequently implemented using sensor modules equipped with one or more, but not limited to, ultrasonic, microwave radar. LIDAR, or depth type camera sensors. These types of depth or distance sensors support continuous measurement of user location. In some embodiments, the system 142 is configured to respond continuously, permitting dimming as a direct function of measured distance to the user, along with the speed and direction of the user, or the monitored area may be divided into discrete sensor zones, as shown here.

FIG. 10B shows multiple sensor zones, for example a sensor module with five sensor zones 62-1 through 62-5, and illustrating a user moving from location X to location Y. The sensor module shown is frequently implemented using multiple PIR sensors but may be implemented using any of the sensing methods described herein.

FIG. 10C shows a table showing thirty seconds of processor module data log reflecting the processor module response as a user moves from Zone 5 (62-5) to Zone 2 (62-2), as illustrated in FIG. 10A and FIG. 10B. The glare reduction system 142 is configured with a system time threshold time of 8 seconds and should trigger a dimming request when the transition time between zones is less than 8 seconds. Additionally, the system dimming timeout is set to 10 seconds so that 10 seconds after the most recent dimming trigger, the system returns to full illumination unless there is a new dimming trigger event.

The first column of the table is a timestamp, the second column is the zone where motion is currently detected, if motion is detected, the third column is the dimming trigger state reflecting the current, if any, active dimming trigger, and the fourth column is the dimming request state showing the percentage of illumination the processor module is requesting for each channel of the external illumination module.

The user is initially stationary at location X in sensor Zone 5 before moving toward location Y. At the five second point in the table, the user is detected entering sensor Zone 4, providing the current location and direction for the user, however the processor module does not generate a dimming trigger because the user speed is not known.

At the 10 second point in the table, the user enters sensor Zone 3, and the processor module generates a dimming trigger for the transition from Zone 4 to Zone 3 because the transition time from entering Zone 4 to entering Zone 3 was five seconds, which is less than the eight second system time threshold, and the processor module commands the illumination module to dim to 100%, 50% and 75% for illumination channels one, two and three, respectively.

At 16 seconds, the processor module detects the user entering sensor Zone 2 and generates a Zone 2 dimming trigger, because the time from entering Zone 3 to entering Zone 1 was 6 seconds, which is less than the system threshold time of 8 seconds, and the processor module sets the illumination module dimming to 50%, 50% and100% for illumination channels one, two and three, respectively

At 21 seconds, the user stops at location Y. No motion is detected at the 22 second mark. At 27 seconds the processor module recognizes that it has been over 10 seconds since the last trigger event, and the system has a 10 second dimming timeout, so the processor module terminates the Zone 2 trigger and returns all illumination channels to full brightness.

FIG. 10D contains a table similar to that of FIG. 10C for glare reduction systems with five sensor zones but showing the dimming response for glare reduction systems paired with an illumination module having a single illumination channel.

FIG. 11A shows a block diagram of the components of a glare reduction system 144 paired with an external illumination module 50. The sensor module 60 contains one or more sensors designed to detect user location, speed and direction within an illuminated area. The processor module 70 reads signals from, and or communicates with, the sensor module, determines when dimming is required, and outputs signals necessary to dim one or more channels of external illumination. In some embodiments, the dimming control signal from the glare reduction 144 system to the illumination module 50 is unidirectional or may be bidirectional.

FIG. 11B shows a block diagram of the components of a glare reduction system 146 with integrated illumination module 50. The sensor module 60 contains one or more sensors designed to detect user location, speed and direction within an illuminated area. The processor module 70 reads signals from, and or communicates with, the sensor module 60, determines when dimming is required, and outputs signals necessary to dim one or more of the integrated illumination channels.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single or specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A glare reduction system, comprising:
an illumination module configured to illuminate an illumination channel;
a sensor module configured to sense movement with a sensor zone; and
a processing module in operative communication with the illumination module and the sensor module, wherein the processing module is programmed to reduce illumination in an illumination channel when the sensor module senses movement of a person within the sensor zone.

2. The glare reduction system of claim 1, wherein the processing module is programmed to reduce illumination in the illumination channel from a first illumination level when the sensor module senses that the person is moving toward the sensor module at a speed faster than a threshold speed.

3. The glare reduction system of claim 2, wherein the processing module is programmed return illumination in the illumination channel to the first illumination level after a predetermined amount of time.

4. The glare reduction system of claim 2, wherein the processing module is programmed return illumination in the illumination channel to the first illumination level if the sensor module senses that the person is moving away from the sensor.

5. The glare reduction system of claim 2, wherein the processing module is programmed to reduce illumination when the sensor module senses that the person is moving toward the sensor module at a speed faster than the threshold speed for a duration longer than a threshold duration.

6. The glare reduction system of claim 1, further comprising at least one additional sensor module, each sensor module defining a sensor zone, wherein the processing module is programmed to reduce illumination in an illumination channel when at least one of sensor module senses movement of a person within the sensor zone.

7. The glare reduction system of claim 6, wherein the processing module is programmed to reduce illumination in the illumination channel when one of the sensor modules senses that the person is moving toward the sensor module at a speed faster than a threshold speed.

8. The glare reduction system of claim 7, wherein the processing module is programmed to reduce illumination when the one of the sensor modules senses that the person is moving toward the one of the sensor modules at a speed faster than the threshold speed for a duration longer than a threshold duration.

9. The glare reduction system of claim 1, further comprising at least one additional illumination module, each illumination module defining at least one illumination channel, wherein the processing module is programmed to reduce illumination at least one of the illumination channels when the one of the sensor modules senses movement of a person towards the one of the sensor modules for a duration longer than the threshold duration.

10. The glare reduction system of claim 9, further comprising a separate sensor module corresponding to each illumination module.

11. The glare reduction system of claim 10, further comprising a separate processing module corresponding to each sensor module.

12. The glare reduction system of claim 11, further comprising a system controller in operable communication with each of the processing modules, wherein the system controller programmed to control at least one of the processing modules in response to signals received by another of the processing modules from the corresponding sensor module.

13. The glare reduction system of claim 1, wherein the processing module is in operative communication with a network.

14. The glare reduction system of claim 1, further configured to be mounted to a vehicle.

15. A vehicle, comprising a plurality of glare reduction systems according to claim 1.
